(19) United States
(12) Patent Application Publication
(10) Pub. No.: US 2016/0124600 A1
(43) Pub. Date: May 5, 2016

(54) FULL-FACE SCREEN USER INTERFACE

(71) Applicant: Microsoft Corporation, Redmond, WA (US)

(72) Inventor: Jean-Philippe Martin, Redmond, WA (US)

(21) Appl. No.: 14/528,813

(22) Filed: Oct. 30, 2014

(51) Int. Cl. G06F 3/0488; G06F 3/0484; G06F 3/044; G06F 3/0481

(52) U.S. Cl. CPC G06F 3/0488; G06F 3/04817; G06F 3/04842; G06F 3/044; G06F 2203/04101

(57) ABSTRACT

A nonbezel touch sensitive user interface may comprise an image that completely covers a face of a device and an overscan located adjacent to the perimeter of the device. The overscan may be overlaid by the image and may provide access to various types of functionality of the device. Touching the overscan may expose functional items within the overscan region. An item may be swiped toward the inner portion of the user interface and out of the overscan, in order to initiate functionality. Access to functionality may be provided based on an amount of time that the overscan is touched. Functionality may be provided based on a nature of a touch of the device. Functionality may be provided based on proximity of the device to an object.

### BACKGROUND

Devices, such as tablets, phones, and phablets may have a touch display user interface that allows a user to provide information to the device. Such devices may have a region, often referred to as a bezel, located at the perimeter of the user interface.

### SUMMARY

The following presents a simplified summary that describes some aspects or configurations of the subject disclosure. This summary is provided to introduce a selection of concepts in a simplified form that are further described below in the Detailed Description. This summary is not intended to identify key features or essential features of the claimed subject matter, nor is it intended to be used to limit the scope of the claimed subject matter. This summary is not an extensive overview of the disclosure. Indeed, additional or alternative configurations of the subject disclosure may be available beyond those described in the summary.

A nonbezel touch sensitive user interface may comprise an image that completely covers a side (surface, side) of a device. A region located adjacent to the perimeter of a surface or side of the device (e.g., a region which may have been utilized as a bezel), referred to herein as an overscan (or overscan region), may be overlaid by the image and may provide access to various types of functionality of the device. In various configurations, when the overscan is touched, functional icons, objects, avatars, emoticons, or the like, may be exposed within the overscan. When the overscan is touched, an image being visually rendered on the user interface may appear to shrink, be cropped, or the like, thus exposing the functional items within the overscan region. In an example configuration, an item may be moved (e.g., swiped) toward the inner portion of the user interface, out of the overscan, in order to initiate functionality. In an example configuration, a timer may be utilized such that when the overscan is touched for at least a threshold amount of time, functionality will not be initiated. And when the overscan is touched for an amount of time less than a threshold amount of time, functionality may be initiated. Thus, this example configuration may allow for a user to hold the device (e.g., while talking on a phone, holding a tablet, etc.) without inadvertently initiating a function available via the overscan. In an example configuration, the proximity of the user interface to an object (e.g., face, ear, head, etc.) may be determined. If the proximity is less than a threshold distance, functionality will not be initiated. If the proximity is greater than or equal to a threshold distance, functionality may be initiated. This example configuration may allow a user to, for example, talk on a phone without inadvertently initiating a function available via the overscan. In an example configuration, the nature of a touch (e.g., palm, fingertip, etc.) may be determined in order to determine if access to device functionality should be provided.

In an example configuration, a device user interface may comprise an overscan portion and an image portion. The overscan portion may be located adjacent to a perimeter of the device. The overscan portion may provide access to device functionality. The image portion may be configured for rendering an image. The image portion may completely overlay the user interface, including the overscan portion.

In an example configuration, a method may comprise providing access to functionality of a device via contact with an overscan portion of a user interface of the device. The user interface may comprise an overscan portion and an image portion. The overscan portion may be located adjacent to a perimeter of the device. The overscan portion may provide access to device functionality. The image portion may be configured for rendering an image. The image portion may completely overlay the user interface, including the overscan portion.

In an example configuration, a computer-readable storage medium may comprise executable instructions that when executed by a processor may cause the processor to effectuate operations. The operations may comprise providing access to functionality of a device via contact with an overscan portion of a user interface of the device. The user interface may comprise an overscan portion and an image portion. The overscan portion may be located adjacent to a perimeter of the device. The overscan portion may provide access to device functionality. The image portion may be configured for rendering an image. The image portion may completely overlay the user interface, including the overscan portion.

### BRIEF DESCRIPTION OF THE DRAWINGS

Reference will now be made to the accompanying drawings, which are not necessarily drawn to scale.

FIG. 1, including FIG. 1A, FIG. 1B, and FIG. 1C, is an illustration of example user interfaces.

FIG. 2, including FIG. 2A and FIG. 2B, is an example illustration of a nonbezel user interface before the overscan is touched as depicted in FIG. 2A and after the overscan is touched as depicted in FIG. 2B.

FIG. 3, including FIG. 3A and FIG. 3B depicts example device functionality available via the overscan.

FIG. 4, including FIG. 4A and FIG. 4B, is an example depiction of functionality being initiated via initial contact on the overscan and subsequent contact out of the overscan.

FIG. 5, including FIG. 5A and FIG. 5B, illustrates scrolling functionality.

FIG. 6 is a block diagram of an example device that may be configurable to implement a nonbezel user interface.

FIG. 7 illustrates an example computing system in which a nonbezel user interface may be implemented.

### DETAILED DESCRIPTION

A large display may be desirable for devices like, for example, tablets, computers, phones, and the like, in order to render as much information as practicable. In an example configuration of a nonbezel user interface as described herein, the display may cover a complete face (surface, side) of a device. A display that visually renders information to the edge of the perimeter of a device, and possible along edges of the device, may provide an opportunity for a user of the device to inadvertently push an on screen button or the like, which could inadvertently initiate device functionality (e.g., make a call, send a text, start a download, etc.).

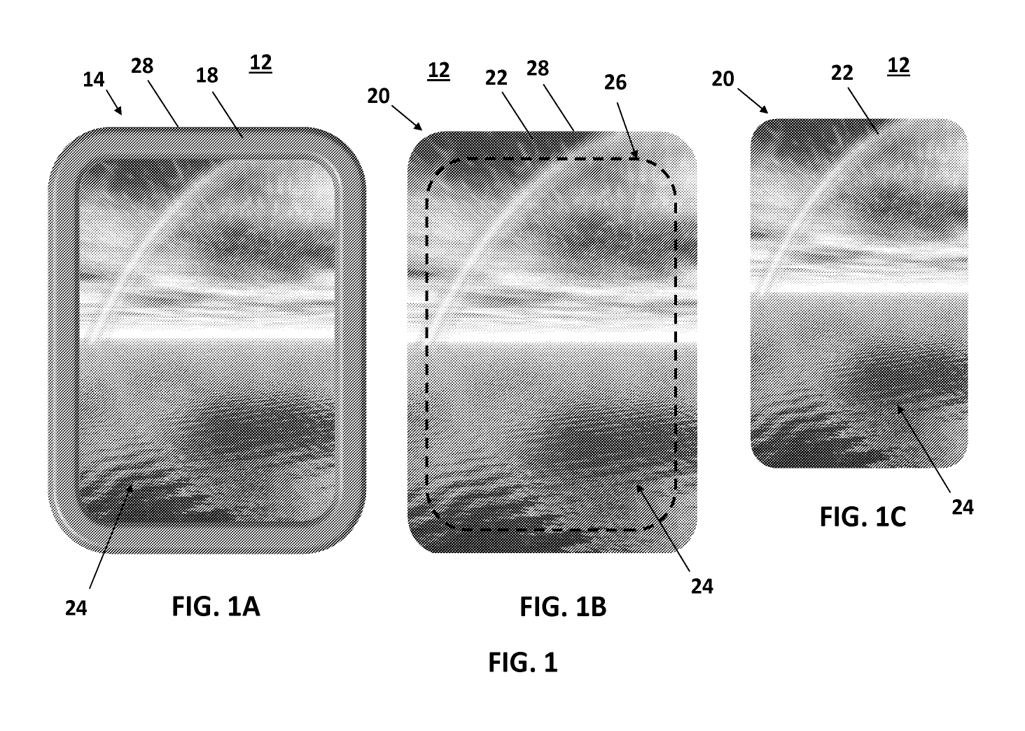

FIG. 1 is an illustration of example user interfaces. As depicted in FIG. 1A, a device 12 may comprise a user interface 14 for interacting with the device 12. The device 12 may comprise a region 18, referred to herein as a bezel, located adjacent to the perimeter 28 of a surface or side of the device 12. As depicted in FIG. 1A, the user interface may comprise a visual rendering of an image 24. FIG. 1B is an example illustration of a nonbezel user interface 20 of the device 12. As depicted in FIG. 1B, a nonbezel user interface does not comprise a bezel. Rather, the nonbezel user interface 20 may comprise a region 22, referred to herein as an overscan, located adjacent to the perimeter 28 of the device 12. FIG. 1B depicts a dashed line 26 to illustrate a boundary of the overscan 22. Thus, as depicted in FIG. 1B, the overscan 22 may be bound on an outer edge by the perimeter 28 of the device 12 and bound on an inner edge by dashed line 26. In an example configuration, the dashed line 26, or any appropriate indication, may be rendered on the user interface 20. In another example configuration, as depicted in FIG. 1C, no visible indication of the inner boundary of the overscan 22 is rendered. Note that that FIG. 1C is smaller than FIG. 1A and FIG. 1B for the sake of clarity. No functional or structural limitation should be inferred from the difference in size of FIG. 1A, FIG. 1B, and FIG. 1C.

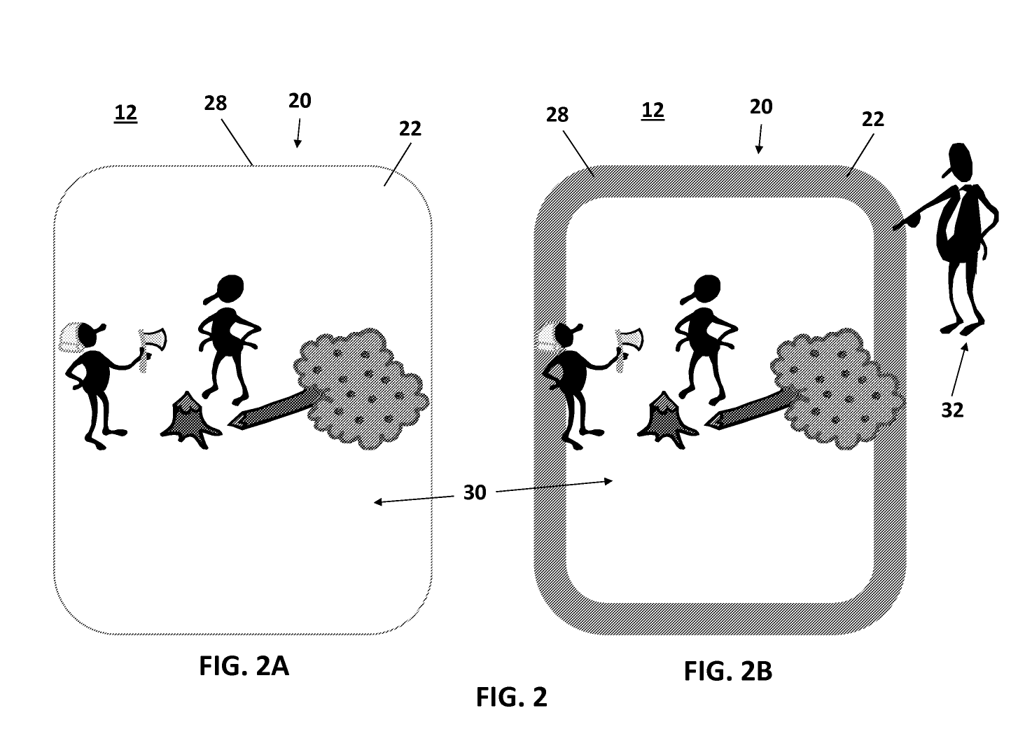

FIG. 2 is an example illustration of a nonbezel user interface before the overscan is touched as depicted in FIG. 2A and after the overscan is touched as depicted in FIG. 2B. As depicted in FIG. 2A, the overscan 22 may comprise a color, pattern, image, portion(s) of an image, video, or the like, to match the image, video, etc. being rendered. Thus, as shown in FIG. 2A, the image/video 30 is overlaid onto the overscan 22. In an example configuration, as depicted in FIG. 2B, when the overscan 22 is touched, as illustrate by screen bean 32, the overscan 22 may become visible. For example, the overscan 22, responsive to being touched, may be visually rendered in a color and/or pattern different from its previous visual rendering and/or different from the image/video 30 being rendered. Thus, any functionality available via the overscan 22 may become apparent.

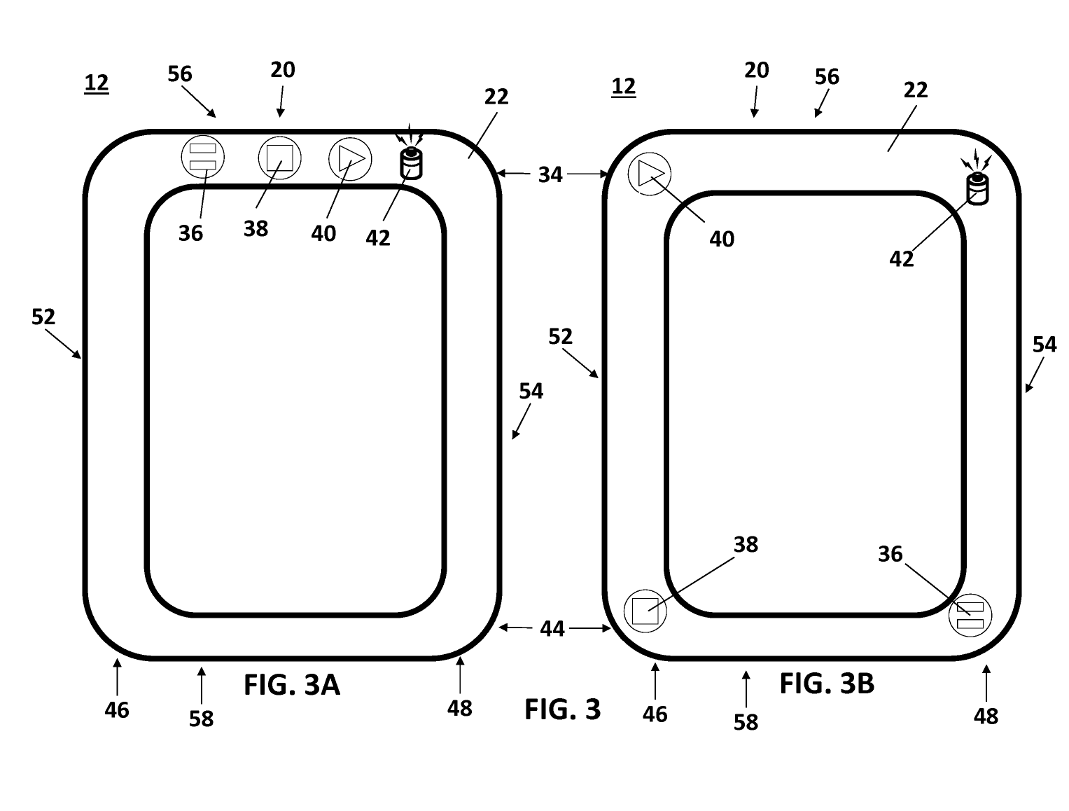

FIG. 3 depicts example device functionality available via the overscan 22. FIG. 3A illustrates icons (buttons, etc.) positioned at a top portion 34 of the overscan 22. The functions depicted in FIG. 3A and in FIG. 3B include a multimedia pause function accessible via icon 36, a multimedia stop function accessible via icon 38, a multimedia play function accessible via icon 40, and an indication of battery life accessible via icon 42. It is to be understood that the icon and functions depicted in FIG. 3 are merely examples and not to be construed as limiting in any manner. Device functionality may be accessible via icons, buttons, or the like, located at any appropriate position within the overscan 22. In an example configuration, to mitigate the potential for a user to inadvertently initiate a function when holding or manipulating the device 20, icons may strategically e positioned within the overscan 22 to avoid a user's touch. For example, if a user is holding the device 20 at the sides 52 and 54, icons may be positioned at the top portion 34 of the overscan 22, the bottom portion 44 of the overscan 22, or any appropriate combination thereof. In an example configuration, if a user is holding the device 20 at the top and bottom 56 and 58 of the device 12, icons may be positioned at the left side portion 46 of the overscan 22, the right side portion 48 of the overscan 22, or any appropriate combination thereof. In an example configuration, icons may be located at corners of the overscan 22 as depicted in FIG. 3B.

In various example, configurations, icons, buttons, or the like, may be positioned within the overscan 22 via any appropriate mechanism. For example, icons may be positioned by a user by touching and sliding an icon to a desired location within the overscan 22. In an example configuration, icons may be positioned within the overscan 22 via voice control commands (e.g., stating that icons should be located to the left, to the right, at the top, at the bottom, at corners, etc.). In an example configuration, when a user touches the device 12, a timer may be started. If the touch (contact with the device 12) is longer than a threshold amount of time (e.g., ½ second, ¼ second, 1 second, 2 seconds, etc.), it may be determined that the device 12 is being held, and that the contact is not meant to initiate functionality. Based on the time of contact exceeding and/or being equal to the threshold amount of time, the device 12 may move icons to locations distant from the location, or locations, of the contact. For example, if icons are located within the overscan 22 at the right side 54 of the device, and contact is detected at the right side 54 for equal to and/or greater than the threshold amount of time, the device 12 may move icons to a portion of the overscan 22 located at the top 34 of the device, a portion of the overscan 22 located at the bottom 44 of the device, a portion of the overscan 22 located at the corners of the device 12, or any appropriate combination thereof.

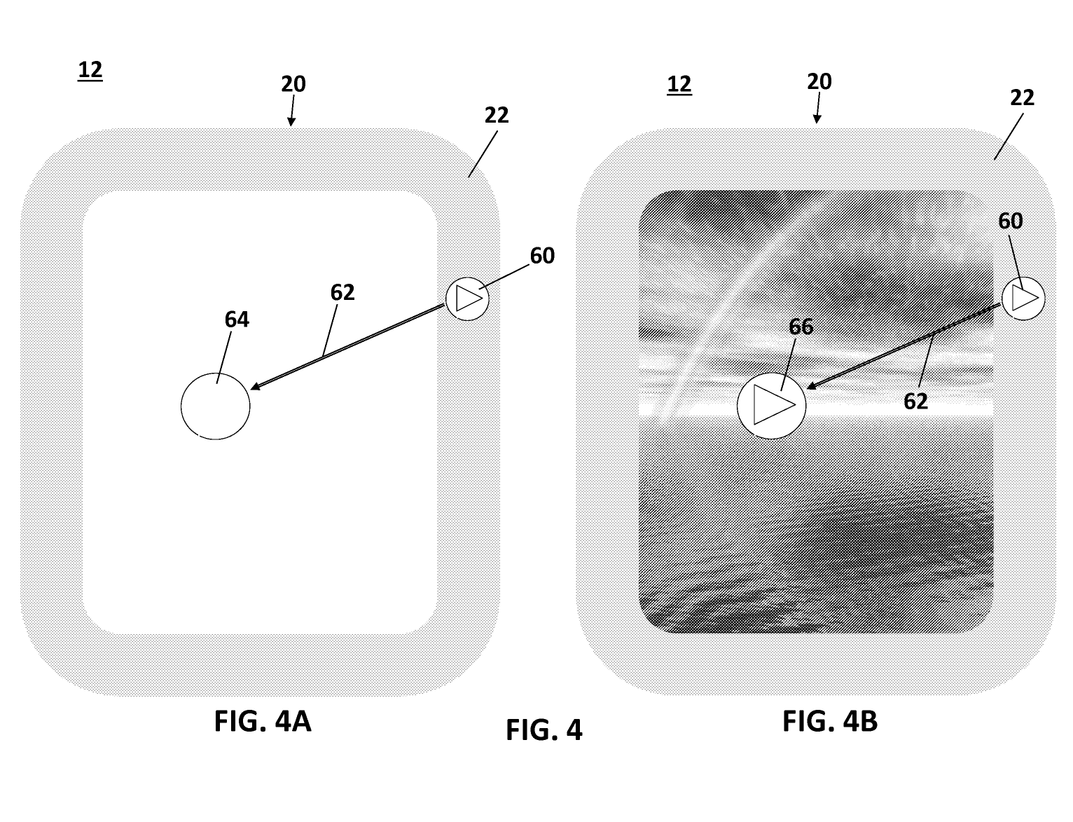

FIG. 4 is an example depiction of functionality being initiated via initial contact on the overscan 22 and subsequent contact out of the overscan 22. In an example configuration, an icon may be moved (e.g., swiped) toward the inner portion of the user interface 20, out of the overscan 22, in order to initiate functionality. For example, as depicted in FIG. 4A and FIG. 4B, a button, icon, item, avatar, or the like 60 may be located within the overscan 22 because it may not obscure a central part a scene, an image, information, or the like. In an attempt to avoid accidental activation of buttons within the overscan 22, pressing (touching, making contact) a button (e.g., icon 60) may result in a line being visibly rendered on the user interface 20 (via a display of the device 12), as depicted by arrow 62. The line may be rendered (drawn) between the icon 60 to a portion (e.g., region 64 depicted in FIG. 4A, region 66 depicted in FIG. 4B) in the inner area of the user interface 20, out of the overscan 22. To initiate functionality, the object (e.g., finger, pointer, etc.) making contact with the icon 60, may slide toward the inner region 64, 66. Upon sliding toward the inner region 64, 66, contact may be withdrawn (released). Upon withdrawal of the contact, functionality accessible via the icon 60 may be initiated. Thus, inadvertent activation of functionality accessible via the overscan 22 may be mitigated or avoided. In an example configuration, a user may drag her finger/pointer from an icon within the overscan 22 to any appropriate region within the user interface 20 and outside of the overscan 22 to initiate functionality.

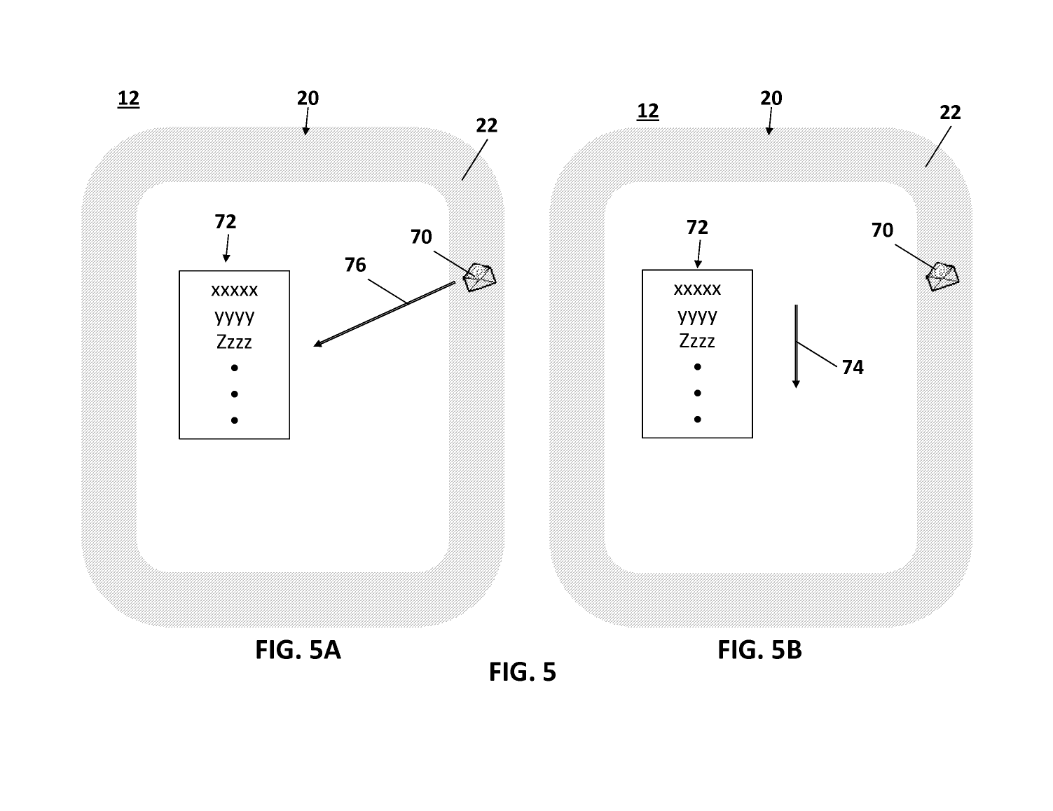

FIG. 5 illustrates scrolling functionality. As shown in FIG. 5A, icon 70 may represent email. Thus, icon 70 may provide access to email functionality. In an example configuration, upon making contact with icon 70, the object making contact (e.g., finger, pointer, etc.) may swipe in the direction of arrow 76. The action of swiping may result in a list of email being visibly rendered on the user interface 20, as depicted by list 72. In an example configuration, swiping toward an inner region of the user interface 20 may result in the list 72 being visibly rendered. In an example configuration, swiping and removing contact may result in the list 72 being visibly rendered. To scroll through the item in the list 72, a user may swipe (e.g., a finger, pointer) within the user interface 20 and outside of the overscan 22. For example, as depicted in FIG. 5B, swiping in the approximate direction of arrow 74 in a region within the user interface 20 and outside of the overscan 22, may provide access to scrolling functionality.

In an example configuration, when contact is made with an icon in the overscan 22, an arrow pointing toward the inner region of the user interface 20 may be visibly rendered, and the swipe gesture is registered with the device 12, upon movement in that direction. In an example configuration, the arrow (e.g., arrow 62) may be animated in any appropriate manner to indicate that the aforementioned swiping should be accomplished. In an example configuration, instead of swiping, a second touch within the user interface 20 and outside of the overscan 22 may be accepted by the device to provide access to functionality.

In an example configuration, the nature of a touch (e.g., palm, fingertip, etc.) may be determined in order to determine if access to device functionality should be provided. For example, the device 12 may determine which hands are grabbing the device 12, and which hands are used for pointing. For example, a slight electric charge or the like, may be utilized on the back of the device 12 in order to distinguish fingers from a hand that is touching the back (presumably grabbing) from one that is not (presumably pointing).

In an example configuration, the proximity of the user interface 20 to an object (e.g., face, ear, head, etc.) may be determined. This may be accomplished via any appropriate manner, such as, for example, via a camera on the device 12, via optical mechanisms on the device 12, via acoustic (ultrasound, sonic), via touch sensors, or the like, or via any appropriate combination thereof. If the proximity is less than a threshold distance (e.g., ½ inch, 1 inch, 2 inches, 3 inches, etc.), functionality will not be initiated. If the proximity is greater than or equal to a threshold distance, functionality may be initiated. This example configuration may allow a user to, for example, talk on a phone without inadvertently initiating a function available via the overscan.

In an example configuration, more complex gestures may be incorporated. For example, the direction of a swipe may determine a variant of functionality. In an example scenario, a single color icon may be shown in the overscan 22. Swiping from the color icon toward an inner region of the user interface and outside of the overscan 22, may cause multiple icons (buttons), representing different colors (e.g., red, green, blue, etc.) to appear (visually rendered) on the user interface 20 nearer the center. Swiping to a desire color may invoke functionality associated with that color. This may also apply to characteristics other than color, such as, for example, fonts, font sizes, drop down menus to select from, or the like.

In an example configuration, a double tap on an icon within the overscan 22 may invoke functionality associated with the icon.

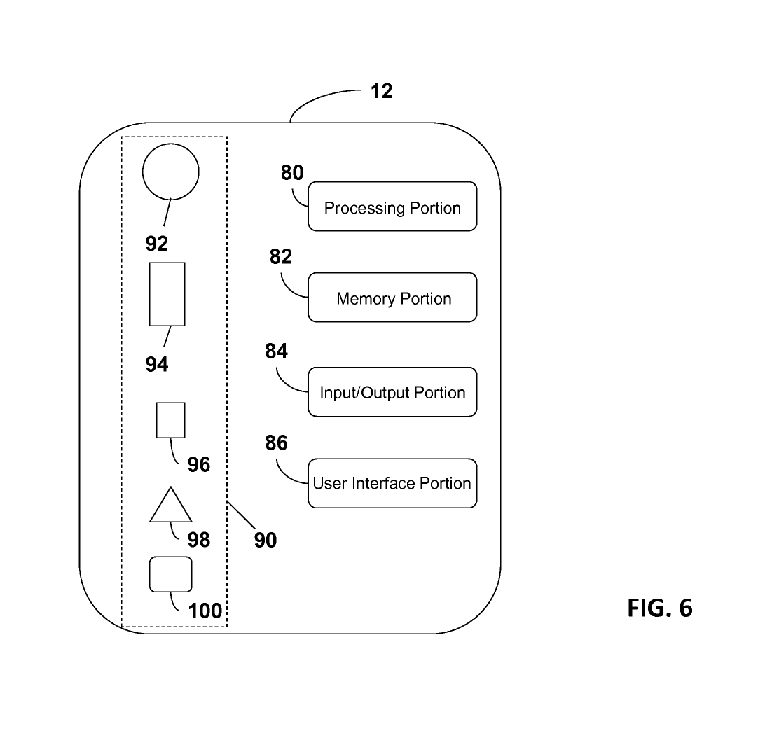

FIG. 6 is a block diagram of an example device 12 that may be configurable to implement a nonbezel user interface. The device 12 may include any appropriate device, mechanism, software, and/or hardware for facilitating a nonbezel user interface as described herein. The device 12 may comprise any appropriate device, examples of which include a portable computing device, such as a laptop, a personal digital assistant (“PDA”), a portable phone (e.g., a cell phone or the like, a smart phone, a video phone), a portable email device, a portable gaming device, a TV, a DVD player, portable media player, (e.g., a portable music player, such as an MP3 player, a walkmans, etc.), a portable navigation device (e.g., GPS compatible device, A-GPS compatible device, etc.), or a combination thereof. The device 12 may include devices that are not typically thought of as portable, such as, for example, a public computing device, a navigation device installed in-vehicle, a set top box, or the like. The device 12 may include nonconventional computing devices, such as, for example, a kitchen appliance, a motor vehicle control (e.g., steering wheel), etc., or the like.

As described herein, the device 12 may comprise hardware, or a combination of hardware and software. And, each portion of the device 12 may comprise hardware, or a combination of hardware and software. Each portion of the device 12, as described herein, may comprise circuitry for performing functions associated with the respective portion. In an example configuration, the device 12 may comprise a processing portion 80, a memory portion 82, an input/output portion 84, a user interface (UI) portion 86 (e.g., user interface 20), and a sensor portion 90 comprising at least one of a video camera portion 92, a force/wave sensor 94, a microphone 96, a moisture sensor 98, a compass 100, or a combination thereof.

The force/wave sensor 94 may comprise at least one of a motion detector, an accelerometer, an acoustic sensor, a tilt sensor, a pressure sensor, a temperature sensor, or the like. The motion detector may be configured to detect motion occurring outside of the communications device, for example via disturbance of a standing wave, via electromagnetic and/or acoustic energy, or the like. The accelerator may be capable of sensing acceleration, motion, and/or movement of the communications device. The acoustic sensor is capable of sensing acoustic energy, such as a noise, voice, etc., for example. The tilt sensor may be capable of detecting a tilt of the device 12. The pressure sensor may be capable of sensing pressure against the device 12, such as from a shock wave caused by broken glass or the like. The temperature sensor may be capable of sensing a measuring temperature, such as inside of the vehicle, room, building, or the like. The moisture sensor 98 may be capable of detecting moisture, such as detecting if the device 12 is submerged in a liquid. The processing portion 80, memory portion 82, input/output portion 84, user interface (UI) portion 86, video camera portion 92, force/wave sensor 94, and microphone 96 are coupled together to allow communications therebetween (coupling not shown in FIG. 6). The device 12 also can comprise a timer (not depicted in FIG. 6).

In various configurations, the input/output portion 84 may comprise a receiver of the device 12, a transmitter of the device 12, or a combination thereof. The input/output portion 84 may be capable of, in conjunction with any other portion of the device 12 as needed, receiving and/or providing information pertaining to a nonbezel user interface as described herein. The input/output portion 84 also may be capable of communications with other devices/sensors, as described herein. For example, the input/output portion 84 may include a wireless communications (e.g., 2.5G/3G/4G/5G) SIM card. The input/output portion 84 may be capable of receiving and/or sending text information, video information, audio information, control information, image information, data, or any combination thereof. In an example configuration, the input/output portion 84 may be capable of receiving and/or sending information to determine a location of the device 12. In an example configuration, the input\output portion 84 may comprise a GPS receiver. In an example configuration, the device 12 may determine its own geographical location through any type of location determination system including, for example, the Global Positioning System (GPS), assisted GPS (A-GPS), time difference of arrival calculations, configured constant location (in the case of non-moving devices), any combination thereof, or any other appropriate means. In various configurations, the input/output portion 84 may receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof. In an example configuration, the input/output portion comprises a WIFI finder, a two-way GPS chipset or equivalent, or the like.

The processing portion 80 may be capable of effectuating a nonbezel user interface as described herein. The processing portion 80, in conjunction with any other portion of the device 12, may provide the ability for users/subscribers to enable, disable, and configure various features of a nonbezel user interface, as described herein. The processing portion 80, in conjunction with any other portion of the device 12 as needed, may enable the device 12 to covert speech to text when it is configured to send text messages. In an example configuration, the processing portion 80, in conjunction with any other portion of the device 12 as needed, may convert text to speech for rendering via the user interface portion 86.

In a basic configuration, the device 12 may include at least one memory portion 82. The memory portion 82 can store any information utilized in conjunction with a nonbezel user interface, as described herein. Depending upon the exact configuration and type of processor, the memory portion 82 may be volatile (such as some types of RAM), nonvolatile (such as ROM, flash memory, for example.). The device 12 may include additional storage (e.g., removable storage and/or non-removable storage) including, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or the like. In an example configuration, the memory portion 82, or a portion of the memory portion 82 may be hardened such that information stored therein may be recovered if the device 12 is exposed to extreme heat, extreme vibration, extreme moisture, corrosive chemicals or gas, or the like. In an example configuration, information stored in the hardened portion of the memory portion 82 may be encrypted, or otherwise rendered unintelligible without use of an appropriate cryptographic key, password, biometric (voiceprint, fingerprint, retinal image, facial image, or the like), wherein, use of the appropriate cryptographic key, password, biometric will render the information stored in the hardened portion of the memory portion 82 intelligible.

The memory portion 82, may comprise a computer-readable storage medium having a concrete, tangible, physical structure. As is known, a signal does not have a concrete, tangible, physical structure. Memory, as well as any computer-readable storage medium described herein, is not to be construed as a signal. The memory, as well as any computer-readable storage medium described herein, is not to be construed as a transient signal. The memory, as well as any computer-readable storage medium described herein, is not to be construed as a propagating signal. The memory, as well as any computer-readable storage medium described herein, is to be construed as an article of manufacture having a concrete, tangible, physical structure.

The device 12 also may contain a UI portion 86 allowing a user to communicate with the device 12. In an example configuration, the UI portion 86 comprises the nonbezel user interface 22 described herein. The UI portion 86 may be capable of rendering any information utilized in conjunction with the device 12 to facilitate a nonbezel user interface as described herein. For example, the UI portion 86 may provide means for entering text, entering a phone number, rendering text, rendering images, rendering multimedia, rendering sound, rendering video, receiving sound, rendering mechanical vibration, swiping, or the like, as described herein. The UI portion 86 may provide the ability to control the device 12, via, for example, buttons, soft keys, voice actuated controls, a touch screen, movement of the mobile device 12, visual cues (e.g., moving a hand or finger in front of a camera on the mobile device 12), or the like. The UI portion 86 may provide visual information (e.g., via a display), audio information (e.g., via speaker), mechanically (e.g., via a vibrating mechanism), or a combination thereof. In various configurations, the UI portion 86 may comprise a display, a touch screen, a keyboard, a speaker, or any combination thereof. The UI portion 86 may comprise means for inputting biometric information, such as, for example, fingerprint information, retinal information, voice information, and/or facial characteristic information. The UI portion 86 may be utilized to enter an indication of the designated destination (e.g., the phone number, IP address, geographic information, or the like).

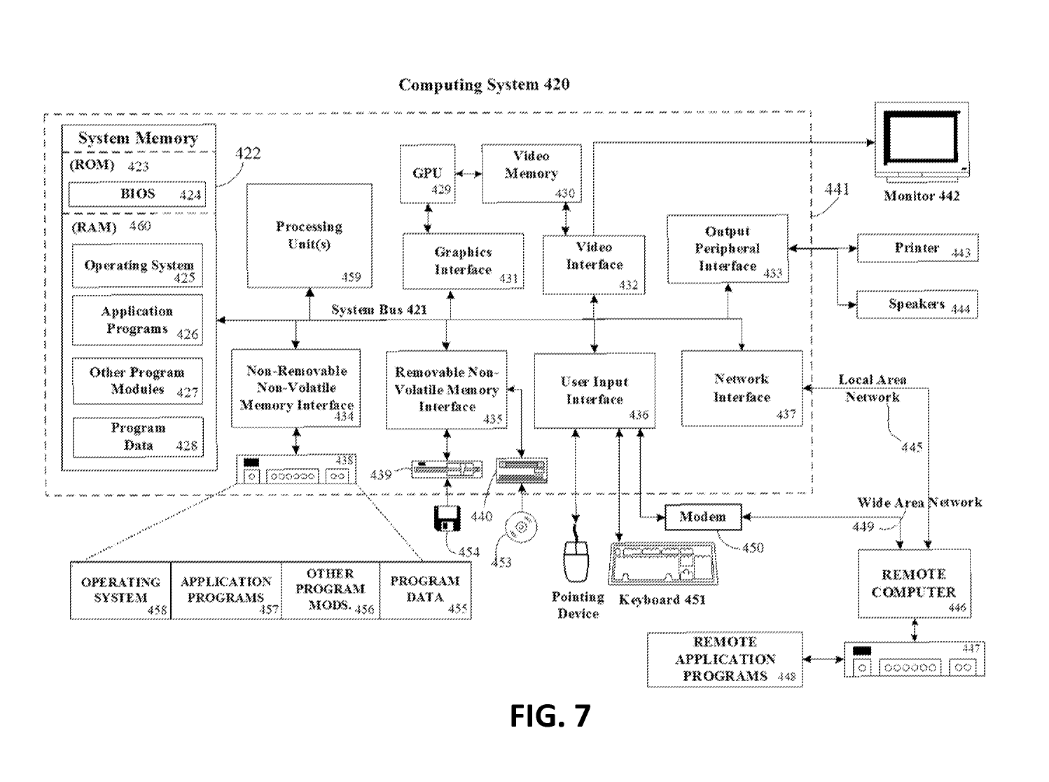

FIG. 7 illustrates an example computing system in which a nonbezel user interface as described herein may be implemented. The computing system 420 is only one example of a suitable computing system and is not intended to suggest any limitation as to the scope of use or functionality of the p subject matter disclosed herein. Neither should the computing system 420 be interpreted as having any dependency or requirement relating to any one or combination of components illustrated in the exemplary computing system 420. In some examples the various depicted computing elements may include circuitry configured to instantiate specific aspects of the present disclosure. For example, the term circuitry used in the disclosure may include specialized hardware components configured to perform function(s) by firmware or switches. In other examples the term circuitry may include a general purpose processing unit, memory, etc., configured by software instructions that embody logic operable to perform function(s). In example examples where circuitry includes a combination of hardware and software, an implementer may write source code embodying logic and the source code may be compiled into machine readable code that may be processed by the general purpose processing unit. Since one skilled in the art may appreciate that the state of the art has evolved to a point where there is little difference between hardware, software, or a combination of hardware/software, the selection of hardware versus software to effectuate specific functions is a design choice left to an implementer. More specifically, one of skill in the art may appreciate that a software process may be transformed into an equivalent hardware structure, and a hardware structure may itself be transformed into an equivalent software process. Thus, the selection of a hardware implementation versus a software implementation is one of design choice and left to the implementer.

Computing system 420 may comprise a computer 441, which may include a variety of computer readable media. Computer readable media may be any available media that may be accessed by computer 441 and includes both volatile and nonvolatile media, removable and non-removable media. The system memory 422 includes computer-readable storage media in the form of volatile and/or nonvolatile memory such as read only memory (ROM) 423 and random access memory (RAM) 460.

The memory 434, 435, 422 and 447 may comprise a storage medium having a concrete, tangible, physical structure. As is known, a signal does not have a concrete, tangible, physical structure. Memory, as well as any computer-readable storage medium described herein, is not to be construed as a signal. The memory, as well as any computer-readable storage medium described herein, is not to be construed as a transient signal. The memory, as well as any computer-readable storage medium described herein, is not to be construed as a propagating signal. The memory, as well as any computer-readable storage medium described herein, is to be construed as an article of manufacture having a concrete, tangible, physical structure.

A basic input/output system 424 (BIOS), containing the basic routines that help to transfer information between elements within computer 441, such as during start-up, is typically stored in ROM 423. RAM 460 typically contains data and/or program modules that are immediately accessible to and/or presently being operated on by processing unit 459. By way of example, and not limitation, FIG. 7 illustrates operating system 425, application programs 426, other program modules 427, and program data 428.

The computer 441 may also include other removable/non-removable, volatile/nonvolatile computer storage media. By way of example only, FIG. 7 illustrates a hard disk drive 438 that reads from or writes to non-removable, nonvolatile magnetic media, a magnetic disk drive 439 that reads from or writes to a removable, nonvolatile magnetic disk 454, and an optical disk drive 440 that reads from or writes to a removable, nonvolatile optical disk 453 such as a CD ROM or other optical media. Other removable/non- removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 438 is typically connected to the system bus 421 through an non- removable memory interface such as interface 434, and magnetic disk drive 439 and optical disk drive 440 are typically connected to the system bus 421 by a removable memory interface, such as interface 435.

The drives and their associated computer storage media discussed above and illustrated in FIG. 7, m a y provide storage of computer readable instructions, data structures, program modules and other data for the computer 441. In FIG. 7, for example, hard disk drive 438 is illustrated as storing operating system 458, application programs 457, other program modules 456, and program data 455. Note that these components may either be the same as or different from operating system 425, application programs 426, other program modules 427, and program data 428. Operating system 458, application programs 457, other program modules 456, and program data 455 are given different numbers here to illustrate that, at a minimum, they are different copies. A user may enter commands and information into the computer 441 through input devices such as a keyboard 451 and pointing device 452, commonly referred to as a mouse, trackball or touch pad. Other input devices (not shown) may include a microphone, joystick, game pad, satellite dish, scanner, or the like. These and other input devices are often connected to the processing unit 459 through a user input interface 436 that is coupled to the system bus, but may be connected by other interface and bus structures, such as a parallel port, game port or a universal serial bus (USB). The cameras 226, 228 and capture device 120 may define additional input devices for the computing system 420 that connect via user input interface 436. A monitor 442 or other type of display device is also connected to the system bus 421 via an interface, such as a video interface 432. In addition to the monitor, computers may also include other peripheral output devices such as speakers 444 and printer 443, which may be connected through a output peripheral interface 433. Capture Device 120 may connect to computing system 420 via output peripheral interface 433, network interface 437, or other interface.

The computer 441 may operate in a networked environment using logical connections to one or more remote computers, such as a remote computer 446. The remote computer 446 may be a personal computer, a server, a router, a network PC, a peer device or other common network node, and typically includes many or all of the elements described above relative to the computer 441, although only a memory storage device 447 has been illustrated in FIG. 7. The logical connections depicted include a local area network (LAN) 445 and a wide area network (WAN) 449, but may also include other networks. Such networking environments are commonplace in offices, enterprise-wide computer networks, intranets and the Internet.

When used in a LAN networking environment, the computer 441 is connected to the LAN 445 through a network interface 437. When used in a WAN networking environment, the computer 441 typically includes a modem 450 or other means for establishing communications over the WAN 449, such as the Internet. The modem 450, which may be internal or external, may be connected to the system bus 421 via the user input interface 436, or other appropriate mechanism. In a networked environment, program modules depicted relative to the computer 441, or portions thereof, may be stored in the remote memory storage device. By way of example, and not limitation, FIG. 7 illustrates application programs 448 as residing on memory device 447. It will be appreciated that the network connections shown are exemplary and other means of establishing a communications link between the computers may be used.

In light of the above, it should be appreciated that many types of physical transformations take place in the architecture 420 in order to store and execute the software components presented herein. It also should be appreciated that the architecture 420 may include other types of computing devices, including hand-held computers, embedded computer systems, smartphones, PDAs, and other types of computing devices known to those skilled in the art. It is also contemplated that the architecture 420 may not include all of the components shown in FIG. 7, may include other components that are not explicitly shown in FIG. 70, or may utilize an architecture completely different from that shown in FIG. 7.

While example configuration of a nonbezel user interface have been described in connection with various computing devices/processors, the underlying concepts may be applied to any computing device, processor, or system capable of facilitating a nonbezel user interface as described herein. The various techniques described herein may be implemented in connection with hardware or software or, where appropriate, with a combination of both. Thus, the methods and apparatuses for implementing a nonbezel user interface, or certain aspects or portions thereof, may utilize program code (i.e., instructions) embodied in tangible storage media having a concrete, tangible, physical, structure. Examples of tangible storage media include floppy diskettes, CD-ROMs, DVDs, hard drives, or any other tangible machine-readable storage medium (tangible computer-readable storage medium). Thus, a tangible storage medium as described herein is not a transient propagating signal. When the program code is loaded into and executed by a machine, such as a computer, the machine becomes an apparatus for implementing a nonbezel user interface. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

As described herein, a device may comprise a user interface comprising an image completely covering a display region of a device and an overscan portion located adjacent to a perimeter of the device and overlaid by the image, the overscan portion providing access to device functionality. The overscan portion may be visibly rendered upon contact with a portion of the user interface that overlays the overscan portion. Access to device functionality may be provided via an icon located within the overscan portion. The device may comprise a processor and memory. The memory may be coupled to the processor. The memory may comprise executable instructions that when executed by the processor cause the processor to effectuate operations comprising detecting contact with the overscan portion, and responsive to detecting the contact, moving an icon to a location within the overscan portion other than a location at which the contact was detected. Access to device functionality may be provided via swiping from the overscan portion to an inner region of the user interface and outside of the overscan portion. Access to device functionality may be provided if contact with the overscan portion is greater than or equal to a threshold amount of time. Access to device functionality may not be provided if contact with the overscan portion is less than a threshold amount of time. Access to device functionality may be provided based on a proximity of the device to an object.

As described herein a method may comprise providing access to functionality of a device via contact with an overscan portion of a user interface of the device. The user interface may comprise an image completely covering a display region of the device and the overscan portion. The overscan portion may be located adjacent to a perimeter of the device and overlaid by the image. The method may comprise visibly rendering the overscan portion upon contact with a portion of the user interface that overlays the overscan portion. The method may comprise providing access to device functionality via an icon located within the overscan portion. The method may comprise detecting contact with the overscan portion and responsive to detecting the contact, moving an icon to a location within the overscan portion other than a location at which the contact was detected. The method may comprise providing access to device functionality via swiping from the overscan portion to an inner region of the user interface and outside of the overscan portion. The method may comprise providing access to device functionality if contact with the overscan portion is greater than or equal to a threshold amount of time. According to the method, access to device functionality may not be provided if contact with the overscan portion is less than a threshold amount of time. The method may provide access to device functionality based on a proximity of the device to an object.

As described herein, a computer-readable storage medium may comprise executable instructions. When the executable instructions are executed by a processor, the processor may effectuate operations comprising providing access to functionality of a device via contact with an overscan portion of a user interface of the device. The user interface may comprise an image completely covering a display region of the device and the overscan portion. The overscan portion may be located adjacent to a perimeter of the device and overlaid by the image. The operations may comprise o visibly rendering the overscan portion may be upon contact with a portion of the user interface that overlays the overscan portion. The operations may comprise providing access to device functionality via an icon located within the overscan portion. The operations may comprise detecting contact with the overscan portion and responsive to detecting the contact, moving an icon to a location within the overscan portion other than a location at which the contact was detected. The operations may comprise providing access to device functionality via swiping from the overscan portion to an inner region of the user interface and outside of the overscan portion. The operations may comprise providing access to device functionality if contact with the overscan portion is greater than or equal to a threshold amount of time. According to the operations, access to device functionality may not be provided if contact with the overscan portion is less than a threshold amount of time. The operations may provide access to device functionality based on a proximity of the device to an object.

The methods and apparatuses for a nonbezel user interface also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for facilitating a nonbezel user interface. When implemented on a general-purpose processor, the program code combines with the processor to provide a unique apparatus that operates to invoke the functionality of a nonbezel user interface.

While a nonbezel user interface has been described in connection with the various configurations of the various figures, it is to be understood that other similar configurations may be used or modifications and additions may be made to the described configuration of a nonbezel user interface without deviating therefrom. A nonbezel user interface should not be limited to any single configuration, but rather should be construed in breadth and scope in accordance with the appended claims.

What is claimed:

1. A device user interface comprising:
an overscan portion located adjacent to a perimeter of the device, the overscan portion providing access to device functionality; and
an image portion for rendering an image, the image portion completely overlaying the user interface, including the overscan portion.

2. The device user interface of claim 1, wherein the overscan portion is visibly rendered upon contact with a portion of the user interface that overlays the overscan portion.

3. The device user interface of claim 1, wherein access to device functionality is provided via an icon located within the overscan portion.

4. The device user interface of claim 1, wherein:
responsive to detecting contact with the overscan portion, an icon is moved to a location within the overscan portion other than a location at which the contact was detected.

5. The device user interface of claim 1, wherein:
access to device functionality is provide via swiping from the overscan portion to an inner region of the user interface and outside of the overscan portion.

6. The device user interface of claim 1, wherein access to device functionality is provided if contact with the overscan portion is greater than or equal to a threshold amount of time.

7. The device user interface of claim 1, wherein access to device functionality is not provided if contact with the overscan portion is less than a threshold amount of time.

8. The device user interface of claim 1, wherein access to device functionality is provided based on a proximity of the device to an object.

9. A method comprising:
providing access to functionality of a device via contact with an overscan portion of a user interface of the device, the user interface comprising:
an overscan portion located adjacent to a perimeter of the device, the overscan portion providing access to device functionality; and
an image portion for rendering an image, the image portion completely overlaying the user interface, including the overscan portion.

10. The method of claim 9, further comprising:
visibly rendering the overscan portion upon contact with a portion of the user interface that overlays the overscan portion.

11. The method of claim 9, further comprising:
providing access to device functionality via an icon located within the overscan portion.

12. The method of claim 9, further comprising:
detecting contact with the overscan portion; and
responsive to detecting the contact, moving an icon to a location within the overscan portion other than a location at which the contact was detected.

13. The method of claim 9, further comprising:
providing access to device functionality via swiping from the overscan portion to an inner region of the user interface and outside of the overscan portion.

14. The method of claim 9, further comprising:
providing access to device functionality if contact with the overscan portion is greater than or equal to a threshold amount of time.

15. The method of claim 9, wherein access to device functionality is not provided if contact with the overscan portion is less than a threshold amount of time.

16. The method of claim 9, further comprising:
providing access to device functionality based on a proximity of the device to an object.

17. A computer-readable storage medium comprising executable instructions that when executed by a processor cause the processor to effectuate operations comprising:
providing access to functionality of a device via contact with an overscan portion of a user interface of the device, the user interface comprising:
an overscan portion located adjacent to a perimeter of the device, the overscan portion providing access to device functionality; and
an image portion for rendering an image, the image portion completely overlaying the user interface, including the overscan portion.

18. The computer-readable storage medium of claim 17, the operations further comprising:
visibly rendering the overscan portion upon contact with a portion of the user interface that overlays the overscan portion.

19. The computer-readable storage medium of claim 17, the operations further comprising:
detecting contact with the overscan portion; and
responsive to detecting the contact, moving an icon to a location within the overscan portion other than a location at which the contact was detected.

20. The computer-readable storage medium of claim 17, the operations further comprising:
providing access to device functionality via swiping from the overscan portion to an inner region of the user interface and outside of the overscan portion.
